(19) United States
(12) Patent Application Publication
(10) Pub. No.: US 2009/0181649 A1
(43) Pub. Date: Jul. 16, 2009

(54) Dynamic Delivery and Presentation of Electronic Data to Mobile Electronic Devices

(76) Inventors: William E. Bull, Campbell, CA (US); Benjamin A. Rottler, Burlingame, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 11/972,570

(22) Filed: Jan. 10, 2008

(51) Int. Cl. H04M 3/42

(52) U.S. Cl. 455/414.1

(57) ABSTRACT

Delivery and/or presentation of electronic data to a mobile electronic device in accordance with a dynamic user profile are disclosed. In one embodiment, as the user profile changes, the electronic data being delivered to and/or presented on the mobile electronic device can dynamically change. In other words, the electronic data being delivered and/or presented can be selected, customized or targeted for characteristics of the dynamic user profile.

### BACKGROUND OF THE INVENTION

1. Field of the Invention

The present invention relates to mobile electronic devices and, more particularly, to providing and presenting information to users of mobile electronic devices.

2. Description of the Related Art

Many people carry at least one mobile electronic device every day and through out the day. These mobile electronic devices tend to be very important digital tools or companions for users. Examples of some common mobile electronic devices are Personal Digital Assistants (PDAs), digital media players, mobile phones, and portable computers. Some mobile electronic devices are able to access wireless networks with network browsers to send and receive data.

Today, users of network browsers can configure their access webpage (e.g., “MyYahoo” provided by Yahoo! Inc.) for a network browser application (e.g., Safari™ application from Apple Inc.) to be presented with information of interest. However, configured preferences or settings that are used to determine the content for the webpage are fixed; hence, the characteristics for the webpage are fixed until subsequently changed through user interaction to alter the preferences or settings.

Information of interest to a user can vary during a relatively short period of time, such as an hour, day or week. However, it is too inconvenient for a user to frequently change their configuration preference or settings to obtain information of current interest. Thus, there is a need for improved approaches to provide a user of mobile electronic device with information that is of current interest.

### SUMMARY OF THE INVENTION

The invention pertains to delivery and/or presentation of electronic data to a mobile electronic device in accordance with a dynamic user profile. In one embodiment, as the user profile changes, the electronic data being delivered to and/or presented on the mobile electronic device can dynamically change. In other words, the electronic data being delivered and/or presented can be selected, customized or targeted for characteristics of the dynamic user profile.

The invention can be implemented in numerous ways, including as a method, system, device, or apparatus (including graphical user interface and computer readable medium). Several embodiments of the invention are discussed below.

As a method for delivering data to a mobile electronic device, one embodiment of the invention can, for example, include at least the acts of: obtaining a dynamic user profile; identifying a remotely located data source that is relevant to the dynamic user profile; and delivering digital data from the identified data source to the mobile electronic device.

As a method for delivering data to a mobile media presentation device, one embodiment of the invention can, for example, include at least the acts of: determining a location of the mobile media presentation device; identifying a data feed associated with the location for the mobile media presentation device; and downloading structured data from the identified data feed to the mobile media presentation device.

As a computer readable medium including at least executable computer program code tangibly stored thereon for delivering data to a mobile electronic device, one embodiment of the invention can, for example, include at least: computer program code for obtaining a dynamic user profile; computer program code for identifying a remotely located data source that is relevant to the dynamic user profile; and computer program code for delivering digital data from the identified data source to the mobile electronic device so that at least a portion of the data delivered to the mobile electronic device can be subsequently presented at the mobile electronic device.

As a computer readable medium including at least executable computer program code tangibly stored thereon for delivering data to a mobile media presentation device, one embodiment of the invention can, for example, include at least: computer program code for determining a location of the mobile media presentation device; computer program code for identifying a data source relevant to the location for the mobile media presentation device; and computer program code for downloading structured data from the identified data source to the mobile media presentation device.

As a portable electronic device, one embodiment of the invention can, for example, include at least: a network interface configured to access one or more wired or wireless networks; a memory configured to store data; a display configured to display data; and a processor. The processor can be configured to (i) dynamically update a user profile having a plurality of characteristics, (ii) receive digital data relevant to the one or more characteristics of the user profile via the network interface, (iii) store the digital data in the memory, and (iv) present at least a portion of the received digital data on the display.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a media delivery system according to one embodiment of the invention.

FIG. 2 is a flow diagram of a data delivery and presentation process according to one embodiment of the invention.

FIG. 3 is a flow diagram of a data download process according to one embodiment of the invention.

FIG. 4 is a flow diagram of a data feed download process according to one embodiment of the invention.

FIG. 5 is a flow diagram of a dynamic presentation process according to one embodiment of the invention.

FIG. 6 illustrates an exemplary mobile device usage system according to one embodiment of the invention.

FIGS. 7A-7E are exemplary display screens illustrating information or data that may be presented on a display screen of a mobile device while at different locations.

FIG. 8 is a block diagram of a mobile multi-function device according to one embodiment of the invention.

### DETAILED DESCRIPTION OF THE INVENTION

The invention pertains to delivery and/or presentation of electronic data to a mobile electronic device in accordance with a dynamic user profile. In one embodiment, as the user profile changes, the electronic data being delivered to and/or presented on the mobile electronic device can dynamically change. In other words, the electronic data being delivered and/or presented can be selected, customized or targeted for characteristics of the dynamic user profile.

The dynamic user profile can be changed by explicit actions, such as configuration by user settings or preferences, or implicit actions, such as user location or user usage. The user profile can be dynamic in that as one or more actions impacting the user profile are discovered, the user profile can, for example, be updated as appropriate.

The invention is, for example, well suited for use on a mobile electronic device, such as a portable communication device (e.g., mobile phone) or a wireless, mobile information appliance (e.g., portable media player with wireless transmission capability) having a display for presenting information to its user.

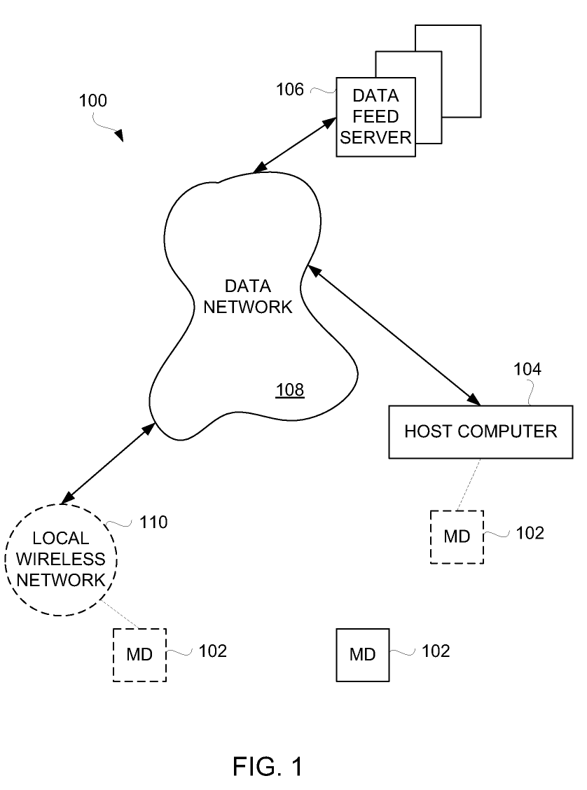

Embodiments of the invention are discussed below with reference to FIGS. 1-8. However, those skilled in the art will readily appreciate that the detailed description given herein with respect to these figures is for explanatory purposes as the invention extends beyond these limited embodiments.

FIG. 1 is a media delivery system 100 according to one embodiment of the invention. The media delivery system 100 supports at least one media device 102. In one embodiment, the mobile device 102 can pertain to a mobile electronic device. One example of a mobile electronic device is a mobile media presentation device, which is a mobile electronic device capable of media presentation. Normally, the media delivery system 100 will support a substantial number of media devices. The media device 102 can couple to a host computer 104. Typically, the media device 102 can be brought within the vicinity of the host computer 104 and then connected either by a wire (e.g., cable or docking device) or by a localized wireless network (e.g., Bluetooth). Once the media device 102 is connected to the host computer 104, the host computer 104 can access information concerning a user profile associated with the user of the mobile device 102. Then, using the user profile, the host computer 104 can interact with at least one of a plurality of data feed servers 106 by way of a data network 108. The data feed server 106 hosts a plurality of different data feeds (or data channels) that are associated with digital content pertaining to different subject matter areas (e.g., different topics, subjects, locations, times, etc.). Based on the user profile, the host computer 104 or the data feed server 106 can select one or a few of the different data feeds to be delivered to the mobile device 102. Here, the selected one or a few of the different data feeds are those of the available data feeds (or channels) that are deemed to be of probable interest to the user. These selected one or a few data feeds can be automatically selected for a user of the mobile device 102. One example of a data feed is a Really Simple Syndication (RSS) feed. More generally, the data feed server 106 can be a data server (or data source) that can provide data to the mobile device 102. The data provided by a data server (or data source) is not limited to data feeds. For example, the data provided by a data server (or data source) can include one or more of auditory, visual and/or other data. Auditory data can, for example, pertain to songs, narrations, or spoken text. Visual data can, for example, pertain to images (e.g., pictures), slideshows or movies. Other data can, for example, include structured data or interpreted data. The structured data or interpreted data can be processed locally by the mobile device which may lead to audio or visual data that can be presented at the mobile device 102.

In addition, in one embodiment, the media delivery system 110 can permit the mobile device 102 to access the data network 108 without use of the host computer 104. In particular, the media delivery system 100 can include a local wireless network 110. The local wireless network 110 can pertain to a WiFi network, a WiMax network or other wireless network which provides wireless access points that facilitate wireless connection to the data network 108. In such an embodiment, the mobile device 102 can interact with at least one of the plurality of data feed servers 102 by way of the local wireless network 110. However, since the mobile device 102 is mobile, the network connectivity is typically only intermittently available to the mobile device 102. When network connectivity is present, the host computer 104 or the data feed server 106 can deliver one or more of the different data feeds to the mobile device 102.

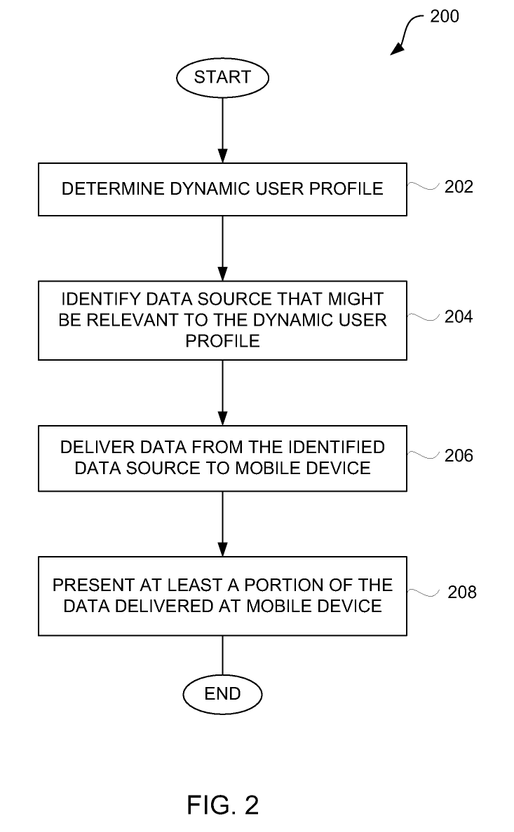

FIG. 2 is a flow diagram of a data delivery and presentation process 200 according to one embodiment of the invention. The data delivery and presentation process 200 is, for example, performed by a computing device, such as the host computer 104 or the mobile device 102 illustrated in FIG. 1.

When the data delivery and presentation process 200 begins, a dynamic user profile for the user of the mobile device can be determined 202. The dynamic user profile can be determined explicitly by the user, implicitly by one or more computing devices, and/or by some combination thereof.

After the dynamic user profile is determined 202, a data source that might be relevant to the dynamic user profile can be identified 204. Thereafter, data (namely, digital data) from the identified data source can be delivered 206 from the identified data source to the mobile device. For example, with reference to FIG. 1, the data can be delivered 206 to the mobile device by way of the host computer 104 or the local wireless network 110.

Finally, at least a portion of the data delivered to the mobile device can be presented 208 at the mobile device. Once the data is delivered to the mobile device, the host computer 104 can present some or all of the data in a rapid manner since the data is locally stored on the mobile device. The presentation of the data can be automatic based on availability of the data or location of the mobile device. The presentation can also be based on user interaction. For example, a user can interact with a user interface for the mobile device to request the data be presented, in which case the data can be rapidly presented.

Following the block 208, the data delivery and presentation process 200 can end. However, it should be recognized that the data delivery and presentation process 200 can be repeated periodically or as the user profile changes.

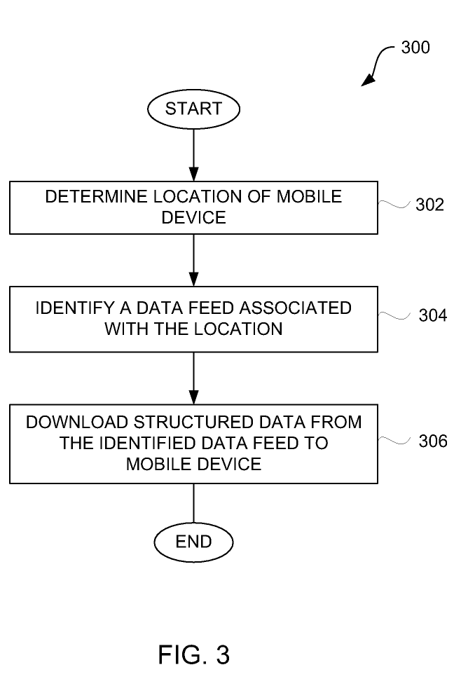

FIG. 3 is a flow diagram of a data download process 300 according to one embodiment of the invention. The data download process 300 is, for example, performed by a computing device, such as the host computer 104 or the mobile device 102 illustrated in FIG. 1.

The data download process 300 can determine 302 a location of a mobile device. The determination 302 of the location of the mobile device can be directly determined, inferred or predicted. After the location of the mobile device has been determined 302, a data feed associated with the location can be identified 302. Next, structured data from the identified data feed can be downloaded 306 to the mobile device. For example, the structured data can be in a markup language format (e.g., eXtensible Markup Language (XML)). After the structured data is downloaded 306, the data download process 300 can end.

The location of the mobile device can be determined by a GPS device, by network triangulation, by network address, by network availability, etc. The location of the mobile device can be inferred or predicted in various ways. As one example, the location of the mobile device can be inferred or predicted by usage (e.g., prefix of local telephone callings being made if the mobile device has voice communications capabilities). As another example, the location of the mobile device can be inferred by user events, such as—a user is on a airline flight to China, then the inferred, future location for the mobile device is China. As another example, if the mobile device includes an electronic calendar for the user, the calendar entries can signal likely location of the mobile device and its user. As still another example, the mobile device can record historical usage and learn the user's normal schedule or routine and thus learn or predict likely locations.

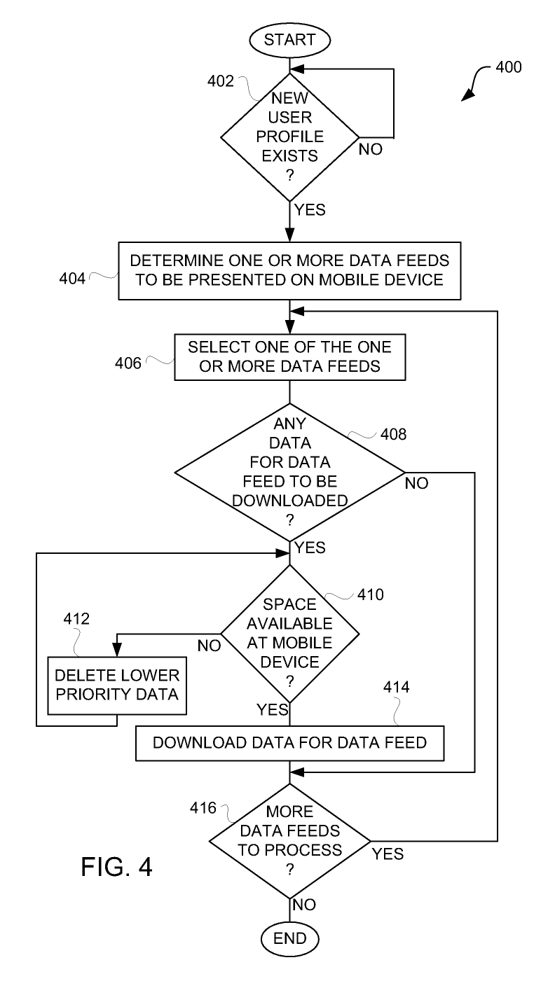

FIG. 4 is a flow diagram of a data feed download process 400 according to one embodiment of the invention. The data feed download process 400 can, for example, be performed by a computing device, such as the host computer 104 illustrated in FIG. 4. In general, the data feed download process 400 locates data feeds that are likely of interest to a user of a mobile device and then downloads the located data feeds to the mobile device.

The data feed download process 400 can begin with a decision 402. The decision 402 can determine whether a new user profile exists. For example, a new user profile can be a newly created user profile or a recently updated user profile, such as a dynamic user profile that has been updated. When the decision 402 determines that a new user profile does not exist, the data feed download process 400 can await a new user profile. On the other hand, when the decision 402 determines that a new user profile does exist, the data feed download process 400 can continue in view of the new user profile.

When the data feed download process 400 continues, one or more data feeds to be presented on the mobile device can be determined 404 based on the new user profile. One of the one or more data feeds can then be selected 406. The selected data feed can then be processed as discussed below. For example, the data feed can be a RSS feed for which an interested party can subscribe to receive occasionally or periodically data feeds. However, more generally, a data feed can be considered one type of data source.

After the one of the one or more data feeds has been selected 406, a decision 408 can determine whether any data for the data feed is to be downloaded. When the decision 408 determines that there is data for the selected data feed to be downloaded, a decision 410 can determine whether there is adequate space available on the mobile device to store such data. When the decision 410 determines that there is inadequate space available on the mobile device, lower priority data previously stored on the mobile device can be deleted 412. Following the block 412, the data feed download process 400 can return to repeat the decision 410. Once the decision 410 determines that there is adequate space available on the mobile device, data for the selected data feed can be downloaded 414 to the mobile device. For example, the data for the selected data feed can be downloaded 414 from the computing device, such as the host computer 104, to the mobile device, such as the mobile device 102.

Following the block 414, or following the decision 408 when there is no data for the selected data feed to be downloaded, a decision 416 can determine whether that are additional data feeds are to be processed. When the decision 416 determines that there are more data feeds to be processed, the data feed download process 400 can return to repeat the block 406 so that another one of the one or more data feeds can be selected and similarly processed. On the other hand, when the decision 416 determines that there are no more data feeds to be processed, the data feed download process 400 can end.

According to one embodiment of the invention, data from a data source, such as a data feed, can be acquired at a mobile device and thereafter presented at the mobile device. The presentation of the data can be visual and/or audio. The presentation of the data can also be automatic (independent of a user request) or on-demand (in response to a user request).

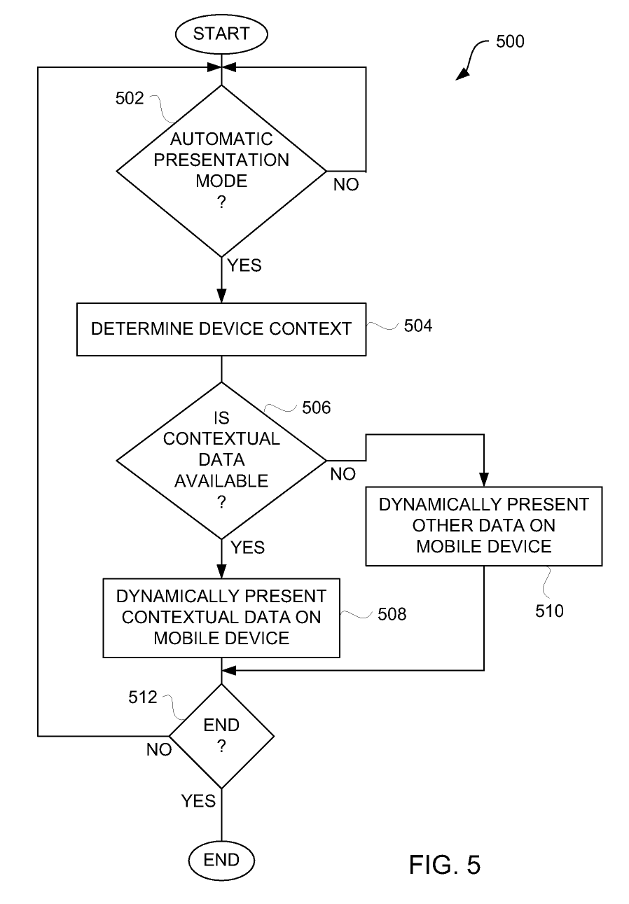

FIG. 5 is a flow diagram of a dynamic presentation process 500 according to one embodiment of the invention. The dynamic presentation process 500 can, for example, be performed by a mobile device, such as the mobile device 102 illustrated in FIG. 1.

The dynamic presentation process 500 can begin with a decision 502. The decision 502 can determine whether an automatic presentation mode is to be utilized. When the decision 502 determines that the automatic presentation mode is not to be used, the dynamic presentation process 500 can await the transition to the automatic presentation mode. On the other hand, when the decision 502 determines that the automatic presentation mode is to be utilized, the dynamic presentation process 500 can continue. In other words, when the automatic presentation mode is to be utilized, the dynamic presentation process 500 can be deemed to be invoked.

Once the decision 502 determines that the automatic presentation mode is to be utilized, a device context for the mobile device can be determined 504. A decision 506 can then determine whether contextual data is available for presentation. Here, depending upon the device context, contextual data may or may not be available on the mobile device. To the extent that contextual data associated with the device context is available on the mobile device, the contextual data can be dynamically presented 508 on the mobile device. In one implementation, the contextual data is data from a data source that can be selected based upon the device context. The context can, for example, be set or influenced by one or more of: device location, device mode and device usage. For example, a data source providing the contextual data can be a selected one of a plurality of data feeds from which relevant data has been downloaded to the mobile device.

Once the contextual data is presented 508 on the mobile device, a decision 512 can determine whether the dynamic presentation process 500 should end. When the decision 512 determines that the dynamic presentation process 500 should not end, then the dynamic presentation process 500 returns to repeat the decision 502 and subsequent blocks so that the automatic presentation mode can continue. In this regard, since the device context can change in a dynamic manner, the contextual data being presented 508 can also change in a dynamic manner. Alternatively, when the decision 512 determines that the dynamic presentation process 500 should end, the dynamic presentation process 510 can end.

Alternatively, when the decision 506 determines that contextual data is not available at the mobile device, other data can be dynamically presented 510 on the mobile device. For example, when contextual data is not available, other data (e.g., on the mobile device) can be chosen by other criteria, such as randomly chosen, and then presented at the mobile device. Following the block 510, the decision 512 can be performed.

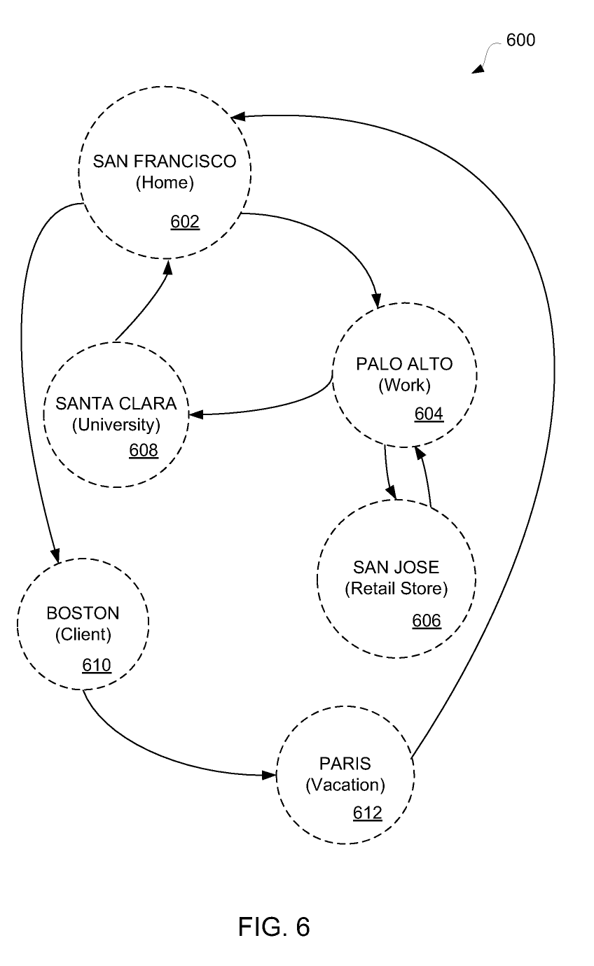

FIG. 6 illustrates an exemplary mobile device usage system 600 according to one embodiment of the invention. With this system 600, it is assumed that a user of a mobile device, such as the mobile device 102 illustrated in FIG. 1, carries the mobile device with them in this exemplary usage scenario.

In the exemplary usage scenario, the user has a home location 602 in San Francisco, and a work location 604 in Palo Alto. Further, the user in this exemplary scenario (on a particular day) the user leaves the home location 602 to go to the work location 604. Sometime later, the user leaves the work location 604 to visit a retail store location 606 in San Jose, and then returns back to the work location 604. Still further, the user thereafter leaves the work location 604 to attend a class at a university location 608 in Santa Clara. After the class at the university location 608 has ended, the user returns to the home location 602. Additionally, on a different day, the user can leave the home location 602 to travel to a Boston location 610 to visit a work client. Then, from the Boston location 610, the user can travel to a vacation location 612, such as Paris. Thereafter, in this exemplary usage scenario, the user can travel from the vacation location 612 back to the home location 602.

While the user in this exemplary usage scenario travels between the various different locations 602-612, the user's mobile device can recognize the general area in which the user is located. Although the location can be a precise location, in one embodiment, the location can be more general such as a city, town, county or region. For example, in the exemplary usage scenario, the locations pertained to cities, namely, San Francisco, Palo Alto, San Jose, Santa Clara, Boston and Paris. While the mobile device is at any of these general locations, the information or data being presented on the display screens associated with the mobile device can be dynamically determined based on the associated location. In other words, the information or data being presented on the display screens associated with the mobile device can be automatically changed to reflect the general location of the mobile device. However, at particular specific location, the information or data being presented could be associated with the specific location as opposed to the general location.

Another exemplary usage scenario is a user that spends most of her time in one geographic location but periodically relocates to a different geographical location. For example, a user might spend 80% of their limit at their primary home location (e.g., San Francisco) and 20% of their time at their secondary home location (e.g., Las Vegas). In such case, the information or data delivered and/or presented at a mobile device can dependent on whether the user is at the primary home location or the secondary home location. This allows the data stored to the mobile device to adapt to the user's location such that when at the different location the mobile device is prepared to rapidly present location-customized data. The location-customized data can also be influenced by user profile or user behavior.

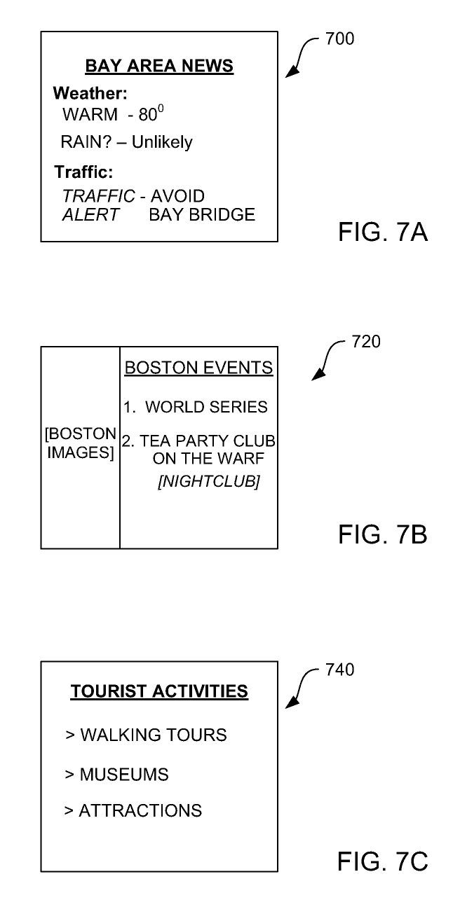

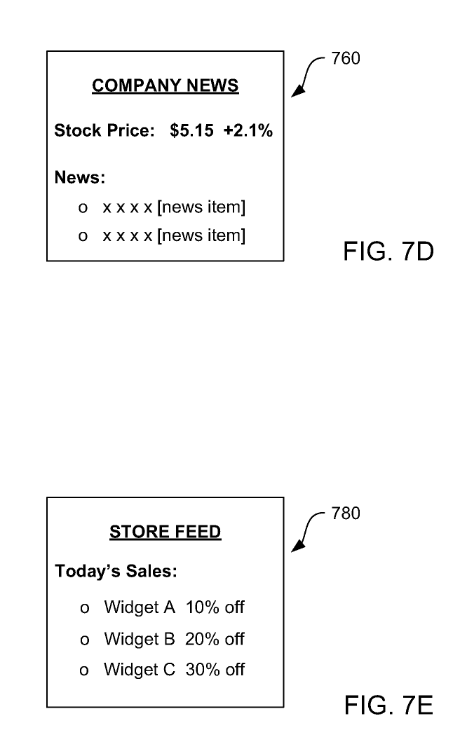

FIGS. 7A-7E are exemplary display screens illustrating information or data that may be presented on a display screen of a mobile device while at different locations.

FIG. 7A illustrates a display screen 700 having “Bay Area News” information. The display screen 700 could, for example, be displayed by the exemplary mobile device usage system 600 when the user of the mobile device is at a Bay Area location, including San Francisco, Palo Alto, San Jose or Santa Clara. In this exemplary display screen 700, the “Bay Area News” information includes a local temperature indication, local whether report, and traffic information.

FIG. 7B illustrates an exemplary display screen 720 corresponding to information regarding the Boston region, which can be displayed to the user while the user of the mobile device is at the client location 610 which is in Boston. The exemplary display screen 720 illustrated in FIG. 7B can contain images concerning Boston as well as Boston events that may be of interest to the user of the mobile device (e.g., sporting event and entertainment event) while being at Boston. In the illustrated example, the sporting event is a World Series baseball game, and the entertainment event is a nightclub party.

In FIG. 7C, an exemplary display screen 740 illustrates a display screen that can be presented while the user of the mobile device is at the vacation location 612. Here, the exemplary display screen 740 contains information on tourist activities, such as walking tours, museum's and other attractions. The exemplary display screen 740 would be useful to the user of the mobile device while the user (and the mobile device) are on vacation at the vacation location 612. In the example illustrated in FIG. 6, the vacation location 612 corresponds to Paris, France; hence, the exemplary display screen 740 can contain tourist information regarding Paris, France.

In FIG. 7D, an exemplary display screen 760 illustrates a display screen that can be presented while the user of the mobile device is at the work location 604. Here, the exemplary display screen 760 contains information on job related information that would be of interest to employees or visitors to the work location 604. For example, as shown in FIG. 7D, the job related information being display can pertain to stock price for the company's stock as well as company news.

In FIG. 7E, an exemplary display screen 780 illustrates a display screen that can be presented while the user of the mobile device is at the retail store location 606. Here, the exemplary display screen 780 contains information pertinent to the retail store. For example, as show in FIG. 7D, the information being displayed can indicate those products on sale at the retail store location 606.

In these exemplary display screens shown in FIGS. 7A-7E, the information or data being presented has been selected, customized or targeted for the geographic location of the mobile electronic device however determined, inferred or estimated.

In a similar fashion, display screens can present information or data that is dependent on one or more characteristics of a dynamic user profile besides or in addition to location. For example, a user on vacation in Paris that likes museums could be presented with the exemplary display screen 612, whereas another user on vacation in Paris that likes antiques could be presented with an exemplary display screen providing information on antique stores or event in Paris.

A user profile is a profile of a user of a device, i.e., the mobile device. The user profile represents the user. The user profile can be set manually by the user or set automatically by the device. A dynamic user profile is a user profile that has an automatic aspect that can cause the user profile to change. User settings can be controlled by hardware or software that enable a user to make selections. Examples of user settings include language settings, topics of interest, geographic interests, user schedule, etc. Accordingly, certain digital data can be promoted to certain users with particular user profiles.

According to another embodiment of the invention data being delivered to mobile devices can be dependent on not only location (e.g., present location, recent locations or frequent locations) but also user demographics. The user demographics can be acquired from a user profile. The user demographics can also be impacted by location. Hence, by classify users with demographic categories, the data delivered to users can be targeted, selected, personalized or customized for such users. As one example, data delivered can be information or data pertaining to digital data (e.g., digital media assets) available from a media repository (e.g., online media store) that are likely to be of interest to a user of a particular demographic category. Certain digital data can be promoted to certain users with particular demographics using this embodiment.

According to another embodiment of the invention data being delivered to mobile devices can be dependent on a behavior profile. Here, instead of a demographic classification, the data to be deliver to a user can be dependent on a behavior profile. The behavior profile can be formed based on locations, user settings, user actions, and/or device usage. Hence, by using behavior profiles, the data delivered to users can be targeted, selected, personalized or customized for such users. As one example, data delivered can be information or data pertaining to digital data (e.g., a digital feed) available from a media repository (e.g., RSS feed source) that is likely to be of interest to a user having a particular behavior profile. Certain digital data can be promoted to certain users with particular behavior profiles using this embodiment.

Since data is able to be delivered to the mobile electronic devices automatically, such as dependent on location, data to be presented is resident (e.g., stored or cached) on the mobile electronic devices. Because the data is locally resident, the data can be presented (e.g., displayed) quickly and efficiently without any need for network access. For example, the exemplary display screens shown in FIGS. 7A-7E can be rapidly presented to users of the mobile electronic devices. In one implementation, the data can be presented in an automatic fashion (without requiring user interaction to cause its presentation). In another implementation, the data can be presented on-demand when requested by a user (such as by user input to the mobile electronic device).

For additional information on providing information to mobile electronic devices, see U.S. application Ser. No. ______, filed concurrently herewith, and entitled “MONITORING CAPABILITIES FOR MOBILE ELECTRONIC DEVICES,” which is hereby incorporated herein by reference.

According to one embodiment, data can be delivered from an information server to a recipient device in an efficient manner. In one implementation, data being delivered can be associated with a template that is present on the recipient device. Accordingly, only data need to be transmitted to the recipient device since the format and other presentation configurations can be controlled by the template. The recipient device can be a mobile device or a host computer. For additional detail on templates, see U.S. application Ser. No. 11/899,024, filed Sep. 4, 2007, and entitled “USER INTERFACE ELEMENTS CLONING AND TRANSITIONS,” which is hereby incorporated herein by reference.

The mobile electronic device utilized herein can, for example, correspond to a computing device (e.g., personal computer), mobile phone (e.g., cellular phone), personal digital assistant (PDA), media player (e.g., music, videos, games, images), media storage device, camera, remote control, and/or the like. In one embodiment, the mobile electronic device can pertain to a mobile media presentation device, which is a mobile electronic device capable of media presentation. The electronic device may also be a multi-functional device that combines two or more of these device functionalities into a single device. Examples of multi-functional devices can be found in U.S. Patent Application Publication No. 20060197753, entitled “MULTI-FUNCTIONAL HAND-HELD DEVICE”, which is herein incorporated by reference.

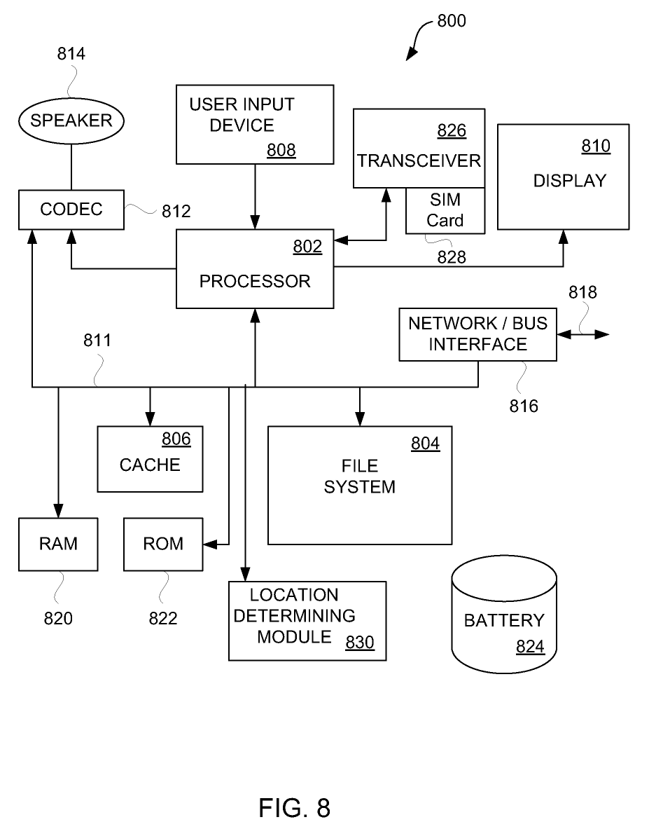

FIG. 8 is a block diagram of a mobile multi-function device 800 according to one embodiment of the invention. The mobile multi-function device 800 can include the circuitry of a portable electronic device that can perform the operations described above. The mobile multi-function device 800 includes hardware and software components to provide at least two functions, namely, a media playback function (including display screen/menu presentations) and a wireless voice communications function. When providing media playback, the mobile multi-function device 800 can operate as a media player capable of playing (including displaying) media items. The media items can, for example, pertain to audio items (e.g., audio files or songs), videos (e.g., movies) or images (e.g., photos). When providing wireless voice communications, the mobile multi-function device 800 can operate as a mobile telephone (e.g., cellular phone).

The mobile multi-function device 800 includes a processor 802 that pertains to a microprocessor or controller for controlling the overall operation of the mobile multi-function device 800. The mobile multi-function device 800 stores media data pertaining to media items in a file system 804 and a cache 806. In one embodiment, the file system 804 is implemented by a storage disk or a plurality of disks. In another embodiment, the file system 804 is implemented by EEPROM or Flash type memory. The file system 804 typically provides high capacity storage capability for the mobile multi-function device 800. However, because the access time to the file system 804 can be relatively slow, the mobile multi-function device 800 can also include a cache 806. The cache 806 is, for example, Random-Access Memory (RAM) provided by semiconductor memory. The relative access time to the cache 806 is substantially shorter than for the file system 804. However, the cache 806 does not have the large storage capacity of the file system 804. Further, the file system 804, when active, consumes more power than does the cache 806. The power consumption is often a concern when the mobile multi-function device 800 is a portable mobile multi-function device that is powered by a battery 824. The mobile multi-function device 800 also includes a RAM 820 and a Read-Only Memory (ROM) 822. The ROM 822 can store programs, utilities or processes to be executed in a non-volatile manner. The ROM 822 can be implemented by an EEPROM or Flash type memory so as to provide writable non-volatile data storage. The RAM 820 provides volatile data storage, such as for the cache 806.

In one embodiment, to support wireless voice communications, the mobile multi-function device 800 includes a transceiver 826 and a SIM card 828. The transceiver 826 supports wireless communication with a wireless network (such as a wireless cellular network). The SIM card 828 includes an identifier (e.g., SIM identifier) can be used by the mobile multi-function device 800 to gain access and utilize the wireless network. In other embodiments, a SIM card 828 is not utilized.

The mobile multi-function device 800 also includes a user input device 808 that allows a user of the mobile multi-function device 800 to interact with the mobile multi-function device 800. For example, the user input device 808 can take a variety of forms, such as a button, keypad, dial, etc. Still further, the mobile multi-function device 800 includes a display 810 (screen display) that can be controlled by the processor 802 to display information to the user. A data bus 811 can facilitate data transfer between at least the file system 804, the cache 806, the processor 802, and the CODEC 812.

In one embodiment, the mobile multi-function device 800 serves to store a plurality of media items (e.g., songs, movies, etc.) in the file system 804. When a user desires to have the mobile multi-function device play a particular media item, a list of available media items is displayed on the display 810. Then, using the user input device 808, a user can select one of the available media items. The processor 802, upon receiving a selection of a particular media item, supplies the media data (e.g., audio file) for the particular media item to a coder/decoder (CODEC) 812. The CODEC 812 then produces analog output signals for a speaker 814. The speaker 814 can be a speaker internal to the mobile multi-function device 800 or external to the mobile multi-function device 800. For example, headphones or earphones that connect to the mobile multi-function device 800 would be considered an external speaker.

The mobile multi-function device 800 also includes a bus interface 816 that couples to a data link 818. The data link 818 allows the mobile multi-function device 800 to couple to a host device (e.g., host computer or power source). The data link 818 can also provide power to the mobile multi-function device 800.

Still further, the mobile multi-function device 830 can include a location determining module 830. The location determining module 830 can determine, assist in determining or store the location of the mobile multi-function device 800. As one example, the location determining module 830 can include at least a global positioning system (GPS) receiver. In another embodiment, the location determining module 830 can include wireless communication circuitry to determine or assist in the determination of the location of the mobile multi-function device 800. For example, the location determining module 830 can use, incorporate or integrate some or all of the transceiver 826. The mobile multi-function device 800 (e.g., the location determining module 830, the file system 804, the RAM 820 and/or the ROM 822) can also store the current location and/or a history of locations for the mobile multi-function device 830.

The portable electronic device utilized herein can further be a hand-held electronic device. The term hand-held generally means that the electronic device has a form factor that is small enough to be comfortably held in one hand. A hand-held electronic device may be directed at one-handed operation or two-handed operation. In one-handed operation, a single hand is used to both support the device as well as to perform operations with the user interface during use. In two-handed operation, one hand is used to support the device while the other hand performs operations with a user interface during use or alternatively both hands support the device as well as perform operations during use. In some cases, the hand-held electronic device is sized for placement into a pocket of the user. By being pocket-sized, the user does not have to directly carry the device and therefore the device can be taken almost anywhere the user travels (e.g., the user is not limited by carrying a large, bulky and often heavy device).

The digital media assets (i.e., digital media items) can pertain to video items (e.g., video files or movies), audio items (e.g., audio files or audio tracks, such as for songs (music), podcasts or audiobooks), or image items (e.g., photos). The digital media assets can also include or be supplemented by text or multimedia files.

The various aspects, features, embodiments or implementations of the invention described above can be used alone or in various combinations.

The invention is preferably implemented by software, hardware, or a combination of hardware and software. The invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The advantages of the invention are numerous. Different aspects, embodiments or implementations may, but need not, yield one or more of the following advantages. One advantage of the invention is that it operates to dynamically receive digital information at a mobile electronic device without user interaction to specifically request such information. The digital information being dynamically (e.g., automatically) received can be determined based on location, usage, configuration or user's interests. Another advantage of the invention is that digital information being received can be determined based on a dynamically determined user profile or behavior profile. Still another advantage of the invention is that digital assets can be provided or made available to targeted users of mobile electronic devices based on a current location of the mobile electronic device, former locations of the mobile electronic device and/or likely future locations of the mobile electronic device. Still another advantage of the invention is that mobile electronic devices can operate to present digital information dynamically without user interaction to specifically request that such information be presented. Yet another advantage of the invention is that it is suitable for use when network connectivity is intermittent.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for delivering data to a mobile electronic device, said method comprising:
obtaining a dynamic user profile;
identifying a remotely located data source that is relevant to the dynamic user profile; and
delivering digital data from the identified data source to the mobile electronic device.

2. A method as recited in claim 1, wherein said method comprises:
determining whether the dynamic user profile has changed; and
repeating said identifying, said delivering and said presenting if said determining determines that the dynamic user profile has changed.

3. A method as recited in claim 1, wherein the data source is a data feed.

4. A method as recited in claim 1, wherein the mobile electronic device is a mobile media presentation device.

5. A method as recited in claim 1, wherein said method further comprises:
subsequently presenting, at the mobile electronic device, at least a portion of the digital data delivered to the mobile electronic device.

6. A method as recited in claim 1,
wherein said identifying of a remotely located data source comprises determining one or more data feeds that are relevant to the dynamic user profile, and
wherein said delivering of digital data from the identified data source comprises (i) determining digital data for the one or more data feeds to be downloaded to the mobile electronic device; and (ii) downloading and storing the digital data from the one or more data feeds to the mobile electronic device.

7. A method as recited in claim 6, wherein said presenting at least a portion of the digital data delivered to the mobile electronic device comprises (i) selecting an appropriate one of the one or more data feeds that are stored on the mobile electronic device based on a current device context of the mobile electronic device; and (ii) displaying data associated with the appropriate one of the one or more data feeds.

8. A method as recited in claim 1,
wherein said identifying of a remotely located data source comprises determining one or more data feeds that are relevant to the dynamic user profile, and
wherein said delivering of digital data from the identified data source comprises (i) determining digital data for the one or more data feeds to be downloaded to the mobile electronic device; (ii) deleting previously stored digital data from other data feeds from the mobile electronic device if additional storage space for storage of the digital data from the one or more data feeds to the mobile electronic device is needed; and (iii) downloading the digital data from the one or more data feeds to the mobile electronic device.

9. A method as recited in claim 1, wherein the dynamic user profile automatically updates.

10. A method as recited in claim 1, wherein at least a portion of the dynamic user profile is inferred.

11. A method for delivering data to a mobile media presentation device, said method comprising:
determining a location of the mobile media presentation device;
identifying a data feed associated with the location for the mobile media presentation device; and
downloading structured data from the identified data feed to the mobile media presentation device.

12. A method as recited in claim 11, wherein said method is performed without user interaction with the mobile media presentation device.

13. A method as recited in claim 11, wherein said method further comprises:
subsequently presenting at least a portion of the structured data from the identified data feed stored at the mobile media presentation device.

14. A method as recited in claim 13, wherein said presenting is automatically performed without any user interaction with the mobile media presentation device to request such presenting.

15. A method as recited in claim 11,
wherein said determining of the location of the mobile media presentation device predicts at least one future location for the mobile media presentation device; and
wherein said identifying of the data feed comprising identifying at least one data feed that is associated with the at least one future location.

16. A computer readable medium including at least executable computer program code tangibly stored thereon for delivering data to a mobile electronic device, said computer readable medium comprising:
computer program code for obtaining a dynamic user profile;
computer program code for identifying a remotely located data source that is relevant to the dynamic user profile;
computer program code for delivering digital data from the identified data source to the mobile electronic device so that at least a portion of the data delivered to the mobile electronic device can be subsequently presented at the mobile electronic device.

17. A computer readable medium including at least executable computer program code tangibly stored thereon for delivering data to a mobile media presentation device, said computer readable medium comprising:
computer program code for determining a location of the mobile media presentation device;
computer program code for identifying a data source relevant to the location for the mobile media presentation device; and
computer program code for downloading structured data from the identified data source to the mobile media presentation device.

18. A portable electronic device, comprising:
a network interface configured to access one or more wired or wireless networks;
a memory configured to store data;
a display configured to display data; and
a processor operatively connected to said network interface, said memory and said display, said processor being configured to (i) dynamically update a user profile having a plurality of characteristics, (ii) receive digital data relevant to the one or more characteristics of the user profile via said network interface, (iii) store the digital data in said memory, and (iv) present at least a portion of the received digital data on the display.

19. A portable electronic device as recited in claim 18, wherein as the user profile dynamically updates, said portable electronic device operates to automatically interact with a remote server to receive digital data relevant to the one or more characteristics of the updated user profile.

20. A portable electronic device as recited in claim 19, wherein the received digital data is associated with a data feed hosted by the remote server, whereby the data feed is relevant to the one or more characteristics of the updated user profile.

21. A portable electronic device as recited in claim 19, wherein the user profile is automatically updated without explicit user interaction with said portable electronic device to alter the user profile.

22. A portable electronic device as recited in claim 18,
wherein the user profile is updated without user interaction with said portable electronic device to alter the user profile, and
wherein once the user profile is updated, said processor operates to receive additional digital data relevant to the one or more characteristics of the updated user profile via said network interface without user interaction with said portable electronic device to request the additional digital data.

23. A portable electronic device as recited in claim 18, wherein at least one of the characteristics of the one or more characteristics of the user profile is a location for said mobile electronic device.
